(19) United States
(12) Patent Application Publication
(10) Pub. No.: US 2016/0205593 A1
(43) Pub. Date: Jul. 14, 2016

(54) TRAFFIC STEERING INTERFACE BETWEEN MOBILE NETWORK OPERATOR AND WI-FI SERVICE PROVIDER

(71) Applicant: NOKIA SOLUTIONS AND NETWORKS OY, Espoo (FI)

(72) Inventors: Risto Antero KAUPPINEN, Espoo (FI); Maximilian RIEGEL, Nürnberg (DE)

(21) Appl. No.: 14/913,108

(22) PCT Filed: Aug. 20, 2013
(86) PCT No.: PCT/EP2013/067285

§ 371 Date: Feb. 19, 2016

(51) Int. Cl. H04W 28/08

(52) U.S. Cl. CPC H04W 28/08; H04W 92/24

(57) ABSTRACT

The present invention addresses a method, apparatus and computer program product for providing a traffic steering interface between mobile network operator and Wi-Fi service provider. With the interface, access point related information from a traffic steering integration component of a Wi-Fi service provider network are forwarded to a traffic steering decision component of a mobile network, and traffic steering action requests from the traffic steering decision component are assigned to the traffic steering integration component.

### FIELD OF THE INVENTION

The present invention generally relates to wireless communication networks, and more specifically relates to a method, apparatus and computer program product for an improved traffic steering interface between mobile network operator and Wi-Fi service provider.

### BACKGROUND

Mobile data transmission and data services are constantly making progress, wherein such services provide various communication services, such as voice, video, packet data, messaging, broadcast, etc. In recent years, Long Term Evolution LTE™ has been specified, which uses the Evolved Universal Terrestrial Radio Access Network E-UTRAN as radio communication architecture according to 3GPP specification.

Furthermore, Wi-Fi™ networks are becoming integral part of mobile broadband. Wi-Fi is already standard feature on user equipments UE, such as smart phones, tablets and laptops.

Major operators are either already using Wi-Fi or planning to deploy Wi-Fi solutions. According to market reports, Wi-Fi usage increases all the time. As Wi-Fi becomes “just another cell” aside mobile radio access networks, operators have already started to require more control and dynamic mechanisms how user device moves between mobile and Wi-Fi networks

Some mobile operators (MNO) do not plan to deploy their own Wi-Fi network, but seek solution to use 3rd party Wi-Fi network offered by Wi-Fi service provider (Wi-Fi SP).

Today, mobile devices with Wi-Fi capability and Wi-Fi profile provisioned are automatically connected to Wi-Fi network whenever they detect suitable Wi-Fi network available. This may be an unsuitable behavior for a MNO, as he wants to use partnered Wi-Fi access only when needed. Rather, the MNO's target is to optimize operating expenses OPEX used for data capacity extension with partnered Wi-Fi access.

### SUMMARY OF THE INVENTION

Therefore, in order to overcome the drawbacks of the prior art, it is an object underlying the present invention to improve traffic steering between mobile network operator and Wi-Fi service provider.

In particular, it is an object of the present invention to provide a method, apparatus and computer program product for an improved traffic steering interface between mobile network operator and Wi-Fi service provider.

According to a first aspect of the present invention, there is provided a method, comprising forwarding access point related information from a traffic steering integration component of a Wi-Fi service provider network to a traffic steering decision component of a mobile network, and assigning traffic steering action requests from the traffic steering decision component to the traffic steering integration component.

According to a second aspect of the present invention, there is provided an apparatus comprising processing means configured to forward access point related information from a traffic steering integration component of a Wi-Fi service provider network to a traffic steering decision component of a mobile network, and assigning means configured to assign traffic steering action requests from the traffic steering decision component to the traffic steering integration component.

According to a third aspect of the present invention, there is provided a system a traffic steering integration point of a Wi-Fi service provider network, configured to decide when and where Wi-Fi access capacity is taken into use, a traffic steering decision component of a mobile network, configured to receive traffic steering requests, to process the requests further, and to realize traffic steering, and an interface between the traffic steering integration component and the traffic steering decision component, wherein the interface comprises an apparatus according to the second aspect.

According to a fourth aspect of the present invention, there is provided a computer program product comprising computer-executable components which, when the program is run, are configured to carry out the method according to the first aspect.

Advantageous further developments or modifications of the aforementioned exemplary aspects of the present invention are set out in the dependent claims.

According to certain embodiments of the present invention, the access point related information is Wi-Fi network topology data.

According to certain embodiments of the present invention, the topology data comprise topology data of accessible access points for traffic offloading.

According to certain embodiments of the present invention, the access point related information is Wi-Fi network status information.

According to certain embodiments of the present invention, the Wi-Fi network status information relate to resources controllable by the mobile network's operator.

According to certain embodiments of the present invention, there is provided the ability to create and configure Wi-Fi network to match cellular network topology for accurate traffic steering. Thereby, the access point related information may be grouped to Wi-Fi access point groups, wherein the access point grouping may be done at mobile network cell level. Further, according to certain embodiments, the access point grouping may be done on geographical level needed for traffic steering, in particular a geographical area by traffic steering purposes.

According to certain embodiments of the present invention, the traffic steering action requests from the traffic steering decision component is based on traffic steering rules defined by the mobile network's operator.

Further, according to certain embodiments of the present invention, the traffic steering decision component collects real-time information of cellular network load of the mobile network.

Further, according to certain embodiments of the present invention, the traffic steering action requests comprise enabling/disabling access to the Wi-Fi network based on cellular congestion or scheduling, e.g. by activation/deactivation of the operator SSID.

Further, according to certain embodiments of the present invention, the traffic steering action requests comprise a query request for the list of manageable access points for a particular region and/or a particular Wi-Fi service.

Still further, the present invention may be implemented as an apparatus comprising at least one processor and at least one memory including computer program code, wherein the at least one memory and the computer program code configured to, with the at least one processor, cause the apparatus at least to perform forwarding access point related information from a traffic steering integration component of a Wi-Fi service provider network to a traffic steering decision component of a mobile network, and assigning traffic steering action requests from the traffic steering decision component to the traffic steering integration component.

### BRIEF DESCRIPTION OF DRAWINGS

For a more complete understanding of example embodiments of the present invention, reference is now made to the following descriptions taken in connection with the accompanying drawings in which:

FIG. 1 shows a deployment model for Traffic Steering Decision (TSD) and Wi-Fi Traffic Steering Integration (TSI) according to certain embodiments of the present invention;

FIG. 2 illustrates a method according to certain embodiments of the invention;

FIG. 3 schematically illustrates an apparatus according to certain embodiments of the invention;

FIG. 4 shows Wi-Fi Service Manager interface: vAP query;

FIG. 5 shows Wi-Fi Service Manager interface: enable/disable vAPs; and

FIG. 6 schematically shows a process of setting a Wi-Fi network for SSID based traffic steering according to certain embodiments of the invention.

### DESCRIPTION OF EXEMPLARY EMBODIMENTS

Exemplary aspects of the present invention will be described herein below. More specifically, exemplary aspects of the present invention are described hereinafter with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

Generally, the present invention addresses a solution to introduce an interface between a mobile network operator MNO and a Wi-Fl service provider Wi-Fi SP for enabling traffic steering controllable by the operator, and to use Wi-Fi access for its subscribers only on need basis.

According to certain embodiments of the present invention, the problem of MNO being able to use Wi-Fi access only when needed is solved by introducing two components and an interface between them. Thereby, one component may reside in the MNO's network, and the other in Wi-Fi SP network.

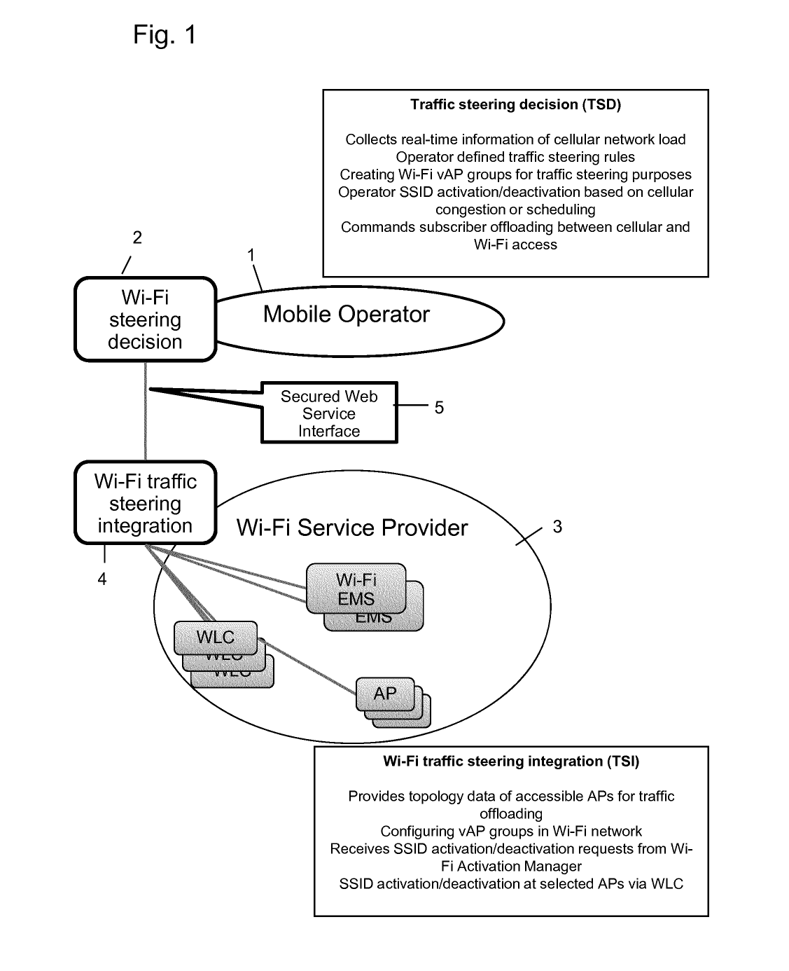

FIG. 1 shows a deployment model for MNO and Wi-Fi SP traffic steering solution.

In particular, as is depicted in FIG. 1, the component in the MNO's network 1 can be generally called as traffic steering decision component (TSD) 2, which makes decisions when and where Wi-Fi access capacity is taken into use.

Thereby, the traffic steering decision component (TSD) 2 is enabled to collect real-time information of cellular network load, to handle operator defined traffic steering rules, to handle enabling/disabling access to the Wi-Fi network based on cellular congestion or scheduling, and to command subscriber offloading between cellular and Wi-Fi access.

The other component that resides in Wi-Fi SP network 3 implements an integration point, which receives traffic steering requests, processes them further and interfaces Wi-Fi network elements to change access point AP configurations to realize traffic steering. This component is called traffic steering integration component (TSI) 4.

Thereby, the Wi-Fi traffic steering integration component (TSI) 4 provides topology data of accessible APs for traffic offloading, receives Wi-Fi network access enabling/disabling requests from the traffic steering decision component, and may handle Wi-Fi network access enabling/disabling at selected APs via a wireless LAN controller WLC.

According to certain embodiments of the present invention, the interface 5 between these two components implements following functionality.

Firstly, it provides Wi-Fi network (AP) topology data to traffic steering decision component.

Further, it may provide Wi-Fi network (AP) status information related to resources controllable by the MNO to traffic steering decision component. The AP status information may contain for example state or load information.

Still further, traffic steering action requests from traffic steering decision component to traffic steering integration component are handled. Traffic steering actions contains selected APs and actions (activate or deactivate Wi-Fi network access).

In case the MNO has its own Wi-Fi network, this interface would be internal interface, but in case operator uses partnered Wi-Fi network, the interface is exposed between the two operators.

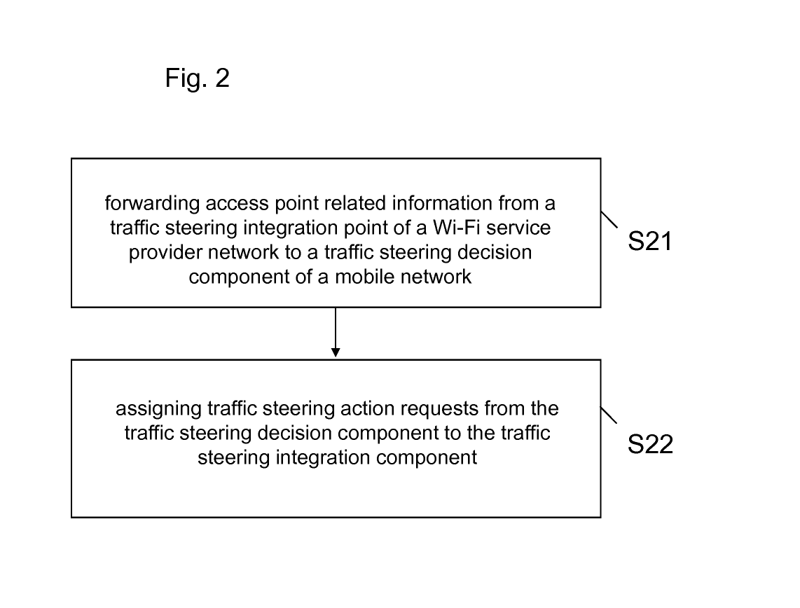

FIG. 2 shows a principle flowchart of an example for a method according to certain embodiments of the present invention.

In Step S21, access point related information are forwarded from a traffic steering integration component of a Wi-Fi service provider network to a traffic steering decision component of a mobile network.

In Step S22, traffic steering action requests from the traffic steering decision component are assigned to the traffic steering integration component.

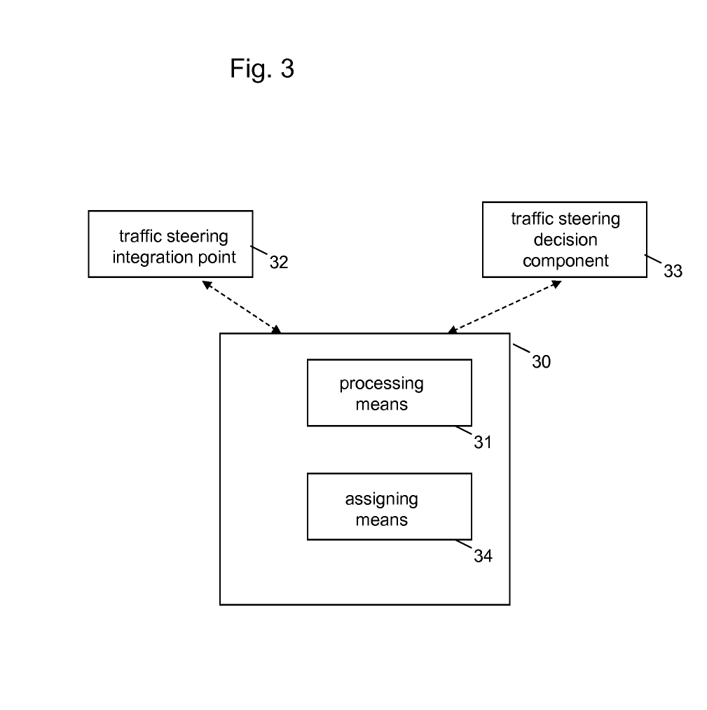

FIG. 3 shows a principle configuration of an example for an apparatus according to certain embodiments of the present invention.

The apparatus 30 comprises a processing means 31 configured to forward access point related information from a traffic steering integration component 32 of a Wi-Fi service provider network to a traffic steering decision component 33 of a mobile network, and assigning means 34 configured to assign traffic steering action requests from the traffic steering decision component 33 to the traffic steering integration component 32.

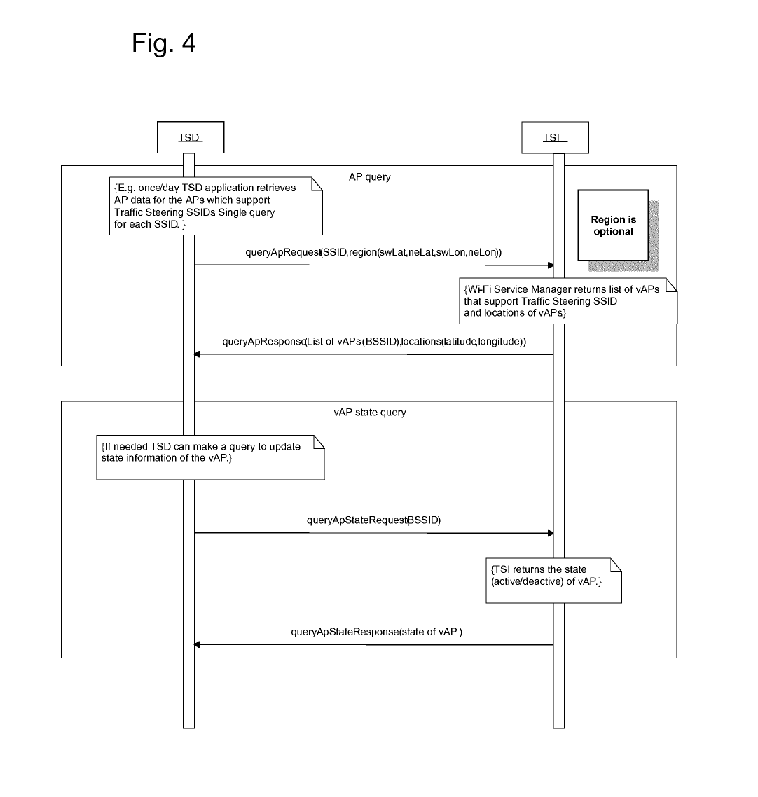

FIG. 4 shows a flow diagram illustrating a data flow of the TSD-TSI interface in case of a virtual access point vAP query.

E.g. once a day (or any arbitrary interval), the TSD retrieves AP data for the APs which support Traffic Steering on their particular Wi-Fi service. Thereby, a single query for each Wi-Fi service offered by the APs is performed.

Therefore, the TSD sends an AP query request message, which may comprise information on the Wi-Fi Service and a region, to the TSI (wherein the region is optional).

The TSI returns a list of virtual access points vAPs that support Traffic Steering on their particular Wi-Fi service and locations of the vAPs.

Then, the TSI transmits an AP query response message comprising the list and the locations to the TSD.

If needed, the TSD can make a query to update status information of the vAPs. Thereby, the TSD transmits an AP state request query message to the TSI.

The TSI returns the status (e.g. state active/inactive) of any or all vAPs to the TSD in an AP state query response message.

Thereby, the TSD may send a ‘define Traffic Steering Area’ request with the list of vAPs of a particular Wi-Fi service, which should build a traffic steering area and a particular Traffic Steering Area Identifier (TSA-ID), which is used afterwards to control that set of vAPs.

Then, the TSI may reply with a ‘Traffic Steering Area TSA-ID defined’ success message, and inturn, the TSD may send steering commands (activate/deactivate TSA-ID) using the TSA-ID as the representative of the vAPs belonging to the traffic steering area.

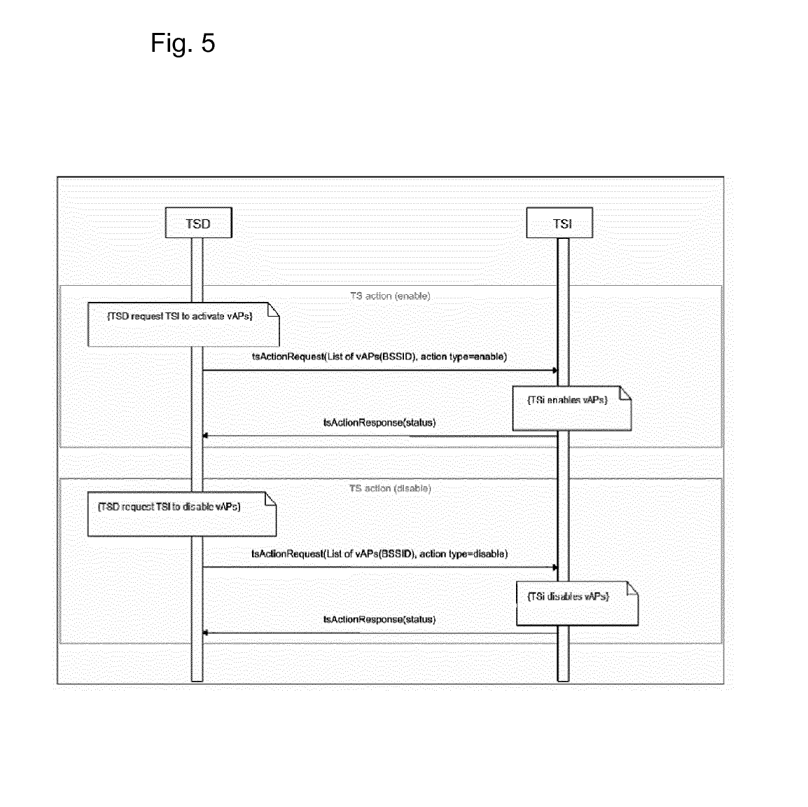

FIG. 5 shows a flow diagram illustrating a data flow of the TSD-TSI interface in case of enable/disable vAPs. The vAPs may be enabled/disabled with the parameters List of vAP ids (Basic Service Set Identification BSSID) and action type (enable/disable).

The TSD requests the TSI to activate vAPs by transmitting a tactical secure TS action request message, which may comprise a list of vAPs (BSSID) and an indication of the action type=enable.

Then, the TSI enables the vAPs and transmits a TS action response message indicating the status to the TSD.

In case of TS action=disable, the TSD requests the TSI to disable the vAPs and transmits a TS action request message to the TSI, which may comprise a list of vAPs (BSSID) and an indication of the action type=disable.

Then, the TSI disables the vAPs and transmits a TS action response message indicating the status to the TSD.

Enabling/disabling of vAPs could be requested individually. Thereby, Traffic Steering Areas, which are forming a group of vAPs, can then be managed (enabled/disabled) with a single id (TSA-ID).

There may be cases in which it is not possible to configure (activate/deactivate) a single virtual AP. Instead, at Wi-Fi network level, there have to be vAP groups for each SSID that is configured/managed as a whole.

Therefore, according to certain embodiments, as further functionality of the TSD-TSI interface according to the present invention, a procedure is provided to collect vAP data for selected SSIDs, assign them to mobile cells, and then (re-) configure vAP group according to be suitable for traffic steering purposes.

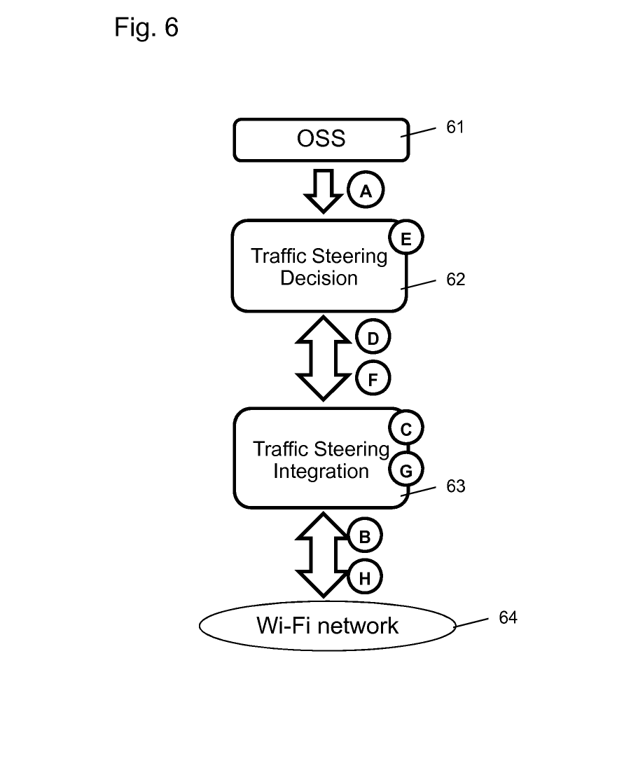

FIG. 6 schematically shows a process of setting a Wi-Fi network for SSID based traffic steering according to certain embodiments of the invention.

According to the process depicted in FIG. 6, a Wi-Fi network 64 is configured to support cellular-Wi-Fi traffic steering. In step A, the TSD 62 reads cellular network topology data from an operational support system OSS 61 (i.e. CM data).

In Step B, the TSI 63 reads the Wi-Fi vAP (per SSID) topology data from the Wi-Fi EMSs. In step C, the TSI 63 stores information of vAPs to its database. The TSI 63 may also determine and store geo-location data of vAPs.

In Step D, the TSD 62 requests vAP topology data for selected SSIDs to be used for traffic steering, and in step E, the TSD 62 assigns vAPs to cells based on for example priority settings, technology priority (e.g. 3G, LTE, 2G) and cell dominance area. vAP groups can be created also for certain geographical areas, not limiting to assigning vAPs to cells.

In step F, the TSD 62 requests the TSI 63 to create vAP groups for each instance that have vAPs assigned, then, in step G, the TSI 63 forms vAP groups and stores them to its database. Finally, in step H, the TSI 63 (re)-configures the Wi-Fi network 64 according to formed vAP groups selected SSIDs. Each vAP group that is created will have unique identifier, vAP group ID, which can be created either by TSD or TSI. From the interface point of vAP group creation request or creation response message will carry the unique vAP group ID that shall be used later to identify vAPs targeted for traffic steering actions.

According to this functionality, those vAP groups are used in traffic steering as follows. When the SSIDs should be activated/deactivated for certain vAPs, then the TSD uses vAP group IDs to identify which vAPs should be activated/deactivated. Further, when the TSI gets a request for a vAP group, then it is able to do the configuration change in Wi-Fi network.

The benefits of the interface between TSD and TSI according to certain embodiments of the present invention are following:
Interface allows transferring crucial information of the Wi-Fi network topology data, which is used for making correct traffic steering actions to steer traffic between cellular and Wi-Fi. From Wi-Fi SP point of view information only related to Wi-Fi resources accessible by MNO is exposed. No information about the particular implementation of the Wi-Fi Service is made accessible to the MNO.
Traffic steering actions are done through the interface toward Wi-Fi SP. No direct access to change Wi-Fi Access Points (AP) configuration is allowed. Wi-Fi SP can process the requests and approve/reject them according to business agreements and other priorities.
Interface can provide status information of the APs operator can control.
Interface implements only certain procedures, which will lower any security risks when Wi-Fi SP exposes an interface for traffic steering.
The interface is independent on the particular method used to enable/disable access to a particular Wi-Fi service, e.g. is works transparently also with the network access control features of Wi-Fi Alliance Passpoint/Hotspot 2.0 secured public access procedures.

Further, it is to be noted that embodiments of the present invention may be implemented as circuitry, in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The present invention relates in particular but without limitation to traffic steering between mobile network and Wi-Fi network. Examples of mobile networks are 2G, 3G, LTE, CDMA, any new radio access in the future. The traffic steering according to the present invention can advantageously be implemented also in controllers, base stations, user equipments or smart phones, or computers connectable to such networks. That is, it can be implemented e.g. as/in chipsets to connected devices.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following meanings for the abbreviations used in this specification apply:
3GPP 3rd Generation Partnership Project
eNB evolved Node B (base station in LTE)
E-UTRAN Evolved Universal Terrestrial Radio Access Network
UE User Equipment
Hetnet Heterogeneous Networks (here 3GPP and Wi-Fi focus, WiMAX not excluded)
MNO Mobile Network Operator
SSID Service Set Identifier
TSD Traffic Steering Decision
TSI Traffic Steering Integration
Wi-Fi SP Wi-Fi Service Provider
vAP virtual Access Point

1-28. (canceled)

29. A method, comprising:
forwarding access point related information from a traffic steering integration component of a Wi-Fi service provider network to a traffic steering decision component of a mobile network; and
assigning traffic steering action requests from the traffic steering decision component to the traffic steering integration component.

30. The method according to claim 29, wherein the access point related information is Wi-Fi network topology data.

31. The method according to claim 30, wherein the topology data comprise topology data of accessible access points for traffic offloading.

32. The method according to claim 29, wherein the access point related information is Wi-Fi network status information.

33. The method according to claim 32, wherein the Wi-Fi network status information relate to resources controllable by the mobile network's operator.

34. The method according to claim 29, wherein the access point related information is grouped to Wi-Fi access point groups.

35. An apparatus comprising
at least one processor; and
at least one memory including computer program code;
the at least one memory and the computer program code configured to, with the at least one processor, cause the apparatus at least to perform
forwarding access point related information from a traffic steering integration component of a Wi-Fi service provider network to a traffic steering decision component of a mobile network; and
assigning traffic steering action requests from the traffic steering decision component to the traffic steering integration component.

36. The apparatus according to claim 35, wherein the access point related information is Wi-Fi network topology data.

37. The apparatus according to claim 36, wherein the topology data comprise topology data of accessible access points for traffic offloading.

38. The apparatus according to claim 35, wherein the access point related information is Wi-Fi network status information.

39. The apparatus according to claim 38, wherein the Wi-Fi network status information relate to resources controllable by the mobile network's operator.

40. The apparatus according to claim 35, wherein the access point related information is grouped to access point groups.

41. The apparatus according to claim 40, wherein the access point grouping is done at mobile network cell level.

42. The apparatus according to claim 40, wherein the access point grouping is done on geographical level needed for traffic steering.

43. The apparatus according to claim 35, wherein the traffic steering action requests from the traffic steering decision component is based on traffic steering rules defined by the mobile network's operator.

44. The apparatus according to claim 35, wherein the traffic steering decision component is configured to collect real-time information of a Wi-Fi network from the traffic steering integration component.

45. The apparatus according to claim 35, wherein the traffic steering action requests comprise offloading Wi-Fi service activation/deactivation based on cellular congestion or scheduling.

46. The apparatus according to claim 35, wherein the traffic steering action requests comprise an access point query request, which comprises information about the Wi-Fi service and/or a region.

47. A system, comprising:
a traffic steering integration component of a Wi-Fi service provider network, configured to receive traffic steering requests, to process the requests further, and to realize traffic steering;
a traffic steering decision component of a mobile network, configured to decide when and where Wi-Fi access capacity is taken into use; and
an interface between the traffic steering integration component and the traffic steering decision component,
wherein the interface comprises an apparatus according to claim 35.

48. A computer program product embodied on a non-transitory distribution medium readable by a computer comprising computer-executable components which, when the program is run, are configured to carry out the method according to claim 29.
